(19) United States
(12) Patent Application Publication
(10) Pub. No.: US 2015/0213229 A1
(43) Pub. Date: Jul. 30, 2015

(54) FAULT DIAGNOSIS METHOD AND APPARATUS

(71) Applicant: Tsinghua University, Beijing (CN)

(72) Inventors: JINGSONG ZHAO, Beijing (CN); YIDAN SHU, Beijing (CN)

(21) Appl. No.: 14/601,354

(22) Filed: Jan. 21, 2015

(30) Foreign Application Priority Data
Jan. 24, 2014 (CN) 201410036478.X

(51) Int. Cl. G06F 19/00; G01M 99/00

(52) U.S. Cl. CPC G06F 19/3437; G01M 99/008

(57) ABSTRACT

A fault diagnosis method is provided. The method includes: performing a technological process of a diagnostic object to obtain an online operation data sample; extracting a first set of data in a first predetermined period of time from the online operation data sample set as a detecting antigen; calculating deviations of the detecting antigen and all of normal antibodies in a normal antibody database to obtain a first deviation set; determining whether each deviation in the first deviation set is less than a normal antibody threshold; if each deviation in the first deviation set is less than the normal antibody threshold, determining that the technological process is normal, else determining that there is a fault in the technological process.

### CROSS-REFERENCE TO RELATED APPLICATION

This application claims priority to and benefits of Chinese Patent Application Serial No. 201410036478.X, filed with the State Intellectual Property Office of P. R. China on Jan. 24, 2014, the entire contents of which are incorporated herein by reference.

### FIELD

The present disclosure relates to a technological process of production technology, and more particularly relates to a fault diagnosis method and a fault diagnosis apparatus.

### BACKGROUND

With the development of science and technology, the complexity of a technological process (such as a chemical process, a refining process or a biological pharmaceutical process) is increased as the days passed. More and more accessory equipments (such as a distributed control system (DCS) or a manufacturing execution system (MES)) are used to monitor an online production process to ensure that the technological process is performed steadily and safely. Meanwhile, with the development of the production automation level, there are fewer operators in a factory compared to the past, such that an operator needs to operate one or more production units or equipments. Since a simple variable alarm cannot provide enough information for the operator to deal with emergencies, the operator often determines a possible state of the technological process by rule of thumb, such that mistakes due to misjudgments or lagging operations of the operator may have serious consequences.

At present a cause of a fault may be discovered and diagnosed in time and possible types of faults may be shown to the operator by establishing a separate fault diagnosis system, such that the stability of the technological process may be guaranteed, serious safety misadventures may be avoided, and the operator can deal with the fault, thus reducing loss due to the fault.

Firstly, a perfect online fault diagnosis system must be based on an effective and efficiency fault diagnosis method to discover a fault quickly once the fault occurs and to diagnose the type of the fault. Secondly, the perfect online fault diagnosis system must have an integrated structure to obtain data from online equipments and to show a diagnosing result to the operator via a friendly interface. Final, the fault diagnosis method must have an adaptive capability and an ability of self-learning, such that the perfect online fault diagnosis system may realize its self-learning by using online data according to operations from the operator to improve its fault diagnosis ability.

An artificial immune system is a comprehensive intelligent system which combines immunology and engineering and builds an immunologic mechanism model by using mathematics, computer science .etc and applies the immunologic mechanism model in the design and implementation of the technological process. A method of determining the ego and nonego used in the artificial immune system is introduced into the field of fault diagnosis. With the dynamitic artificial immune system, dynamic variables in the technological process are defined as driving parameters, historical data is defined as an antibody and online data is defined as an antigen according to dynamic characteristics of the technological process, such that the fault diagnosis may be performed on the technological process by calculating the deviation of the antigen and the antibody.

However, there is a lack of historical data without performing the technological process for a long time. In this case, due to lacking historical data, the fault diagnosis cannot be performed effective by using the dynamic artificial immune system.

### SUMMARY

The present disclosure is aimed to solve at least one of the above problems.

Thus, a first objective of the present disclosure is to provide a fault diagnosis method. The method can overcome the problem of lacking historical data of a technological process and can discover a fault occurring in the technological process accurately and quickly and can determine a type of the fault.

In order to achieve the above objective, embodiments of the present disclosure provide a fault diagnosis method, comprising: performing a technological process of a diagnostic object to obtain an online operation data sample; extracting a first set of data in a first predetermined period of time from the online operation data sample as a detecting antigen; calculating deviations of the detecting antigen and all of normal antibodies in a normal antibody database to obtain a first deviation set, wherein the normal antibody database is generated according to operation data of a transplant provider corresponding to the diagnostic object in a plurality of operating conditions and historical data of the diagnostic object in the plurality of operating conditions; determining whether each deviation in the first deviation set is less than a normal antibody threshold; if each deviation in the first deviation set is less than the normal antibody threshold, determining that the technological process is normal, else determining that there is a fault in the technological process.

In some embodiments, the method further comprises: determining a type of the fault in the technological process, if there is the fault in the technological process.

In some embodiments, determining the type of the fault in the technological process comprises: obtaining a diagnosing antigen according to the detecting antigen; calculating deviations of the diagnosing antigen and all of fault antibodies in a plurality of fault antibody databases to obtain a second deviation set, wherein the plurality of fault antibody databases are generated according to the operation data of the transplant provider in the plurality of operating conditions and the historical data of the diagnostic object in the plurality of operating conditions; if there is a deviation of the diagnosing antigen and a fault antibody from a fault antibody database is less than a fault antibody threshold corresponding to the fault antibody database, determining that the fault is a type of fault corresponding to the fault antibody database.

In some embodiments, generating the normal antibody database and the plurality of fault antibody databases comprises: determining the transplant provider according to process information, operating regulations and existing historical data of the diagnostic object; generating a normal sample set and a fault sample set according to the operation data of the transplant provider in the plurality of operating conditions; extracting data in a second predetermined period of time from the normal sample set to generate a normal vaccine, and extracting data in a third predetermined period of time from the fault sample set to generate a plurality of fault vaccines corresponding respectively to the plurality of types of faults; generating a historical normal sample set and a historical fault sample set according to the historical data of the diagnostic object in the plurality of operating conditions; obtaining a first immune coefficient of the normal vaccine according to the historical normal sample set and the normal vaccine, and generating the normal antibody database according to the normal vaccine and the first immune coefficient; obtaining a plurality of second immune coefficients of the plurality of fault vaccines according to the historical fault sample set and the plurality of fault vaccines, and generating the plurality of fault antibody databases according to the plurality of fault vaccines and the plurality of second immune coefficients.

In some embodiments, the technological process comprises a start-up procedure and a steady-state operation procedure, the normal sample set comprises a first normal start-up sample set comprising normal data in the start-up procedure of the transplant provider and a first normal steady-state sample set comprising normal data in the steady-state operation procedure of the transplant provider; the historical normal sample set comprises a second normal start-up sample set comprising normal data in the start-up procedure of the diagnostic object and a second normal steady-state sample set comprising normal data in the steady-state operation procedure of the diagnostic object; the fault sample set comprises a first fault start-up sample set comprising fault data of a plurality of types of faults occurring in the start-up procedure of the transplant provider and a first fault steady-state sample set comprising fault data of the plurality of types of faults occurring in the steady-state operation procedure of the transplant provider; the historical fault sample set comprises a second fault start-up sample set comprising fault data of the plurality of types of faults occurring in the start-up procedure of the diagnostic object and a second fault steady sample set comprising fault data of the plurality of types of faults occurring in the steady-state operation procedure of the diagnostic object.

In some embodiments, obtaining a second immune coefficient of a fault vaccine according to the historical fault sample set and the fault vaccine in the start-up procedure comprises: calculating a first deviation matrix according to the second normal start-up sample set and the second fault start-up sample set; calculating a second deviation matrix according to the normal vaccine and the fault vaccine; calculating the second immune coefficient according to the first deviation matrix and the second deviation matrix.

In some embodiments, obtaining a second immune coefficient of a fault vaccine according to the historical fault sample set and the fault vaccine in the steady-state operation procedure comprises: calculating a third deviation matrix according to the second fault steady-state sample set; calculating a fourth deviation matrix according to the fault vaccine; calculating the second immune coefficient according to the third deviation matrix and the fourth deviation matrix.

In some embodiments, obtaining a diagnosing antigen according to the detecting antigen comprises: if the fault occurs in the second start-up procedure, obtaining a second set of data in an operating condition the same as a current operating condition from the second normal start-up sample set and calculating a fifth deviation matrix to obtain the diagnosing antigen according to the detecting antigen and the second set of data; if the fault occurs in the second steady-state operation procedure, obtaining the diagnosing antigen by subtracting operation data at a time when the fault is determined from each online operation data in the detecting antigen.

In some embodiments, the method further comprises updating the normal antibody database through online operation data according to a comparison of the detecting antigen and the normal antibody database; or updating the plurality of fault antibody databases through the online operation data according respectively to a plurality of comparisons of the diagnosing antigen and the plurality of fault antibody databases.

A second objective of the present disclosure is to provide a fault diagnosis apparatus. The apparatus comprises a performing module, configured to perform a technological process of a diagnostic object to obtain an online operation data sample; an extracting module, configured to extract a first set of data in a first predetermined period from the online operation data sample as a detecting antigen; a first calculating module, configured to calculate deviations of the detecting antigen and all of normal antibodies in a normal antibody database to obtain a first deviation set; a judging module, configured to judge whether each deviation in the first deviation set is less than a normal antibody threshold; a first determining module, configured to determine that the technological process is normal if each deviation in the first deviation set is less than the normal antibody threshold, and to determine that there is a fault in the technological process if a deviation in the first deviation set is greater than or equal to the normal antibody threshold.

In some embodiments, the apparatus further comprises a second determining module, configured to determine a type of the fault in the technological process, if there is the fault in the technological process.

In some embodiments, the second determining module comprises: a first obtaining unit, configured to obtain a diagnosing antigen according to the detecting antigen; a calculating unit, configured to calculate deviations of the diagnosing antigen and all of fault antibodies in a plurality of fault antibody databases to obtain a second deviation set; a first determining unit, configured to determine that the fault is a type of fault corresponding to the fault antibody database if there is a deviation of the diagnosing antigen and a fault antibody from a fault antibody database is less than a fault antibody threshold corresponding to the fault antibody database.

In some embodiments, the apparatus further comprises a generating module, configured to generate the normal antibody database and the plurality of fault antibody databases according to operation data of a transplant provider corresponding to the diagnostic object in a plurality of operating conditions and historical data of the diagnostic object in the plurality of operating conditions; wherein the generating module comprises: a second determining unit, configured to determine the transplant provider according to process information, operating regulations and existing historical data of the diagnostic object; a first generating unit, configured to generate a normal sample set and a fault sample set according to the operation data of the transplant provider in the plurality of operating conditions; an extracting unit, configured to extract data used in a second predetermined period of time from the normal sample set to generate a normal vaccine, and to extract data in a third predetermined period of time from the fault sample set to generate a plurality of fault vaccines corresponding respectively to the plurality of types of faults; a second generating unit, configured to generate a historical normal sample set and a historical fault sample set according to the historical data of the diagnostic object in the plurality of operating conditions; a second obtaining unit, configured to obtain a first immune coefficient of the normal vaccine according to the historical normal sample set and the normal vaccine, and to generate the normal antibody database according to the normal vaccine and the first immune coefficient; a third obtaining unit, configured to obtain a plurality of second immune coefficients of the plurality of fault vaccines according to the historical fault sample set and the plurality of fault vaccines, and to generate the plurality of fault antibody databases according to the plurality of fault vaccines and the plurality of second immune coefficients.

In some embodiments, the technological process comprises a start-up procedure and a steady-state operation procedure; the normal sample set comprises a first normal start-up sample set comprising normal data used in the start-up procedure of the transplant provider and a first normal steady-state sample set comprising normal data used in the steady-state operation procedure of the transplant provider; the historical normal sample set comprises a second normal start-up sample set comprising normal data used in the start-up procedure of the diagnostic object and a second normal steady-state sample set comprising normal data used in the steady-state operation procedure of the diagnostic object; the fault sample set comprises a first fault start-up sample set comprising fault data of a plurality of types of faults occurring in the start-up procedure of the transplant provider and a first fault steady-state sample set comprising fault data of the plurality of types of faults occurring in the steady-state operation procedure of the transplant provider; the historical fault sample set comprises a second fault start-up sample set comprising fault data of the plurality of types of faults occurring in the start-up procedure of the diagnostic object and a second fault steady sample set comprising fault data of the plurality of types of faults occurring in the steady-state operation procedure of the diagnostic object.

In some embodiments, obtaining a second immune coefficient of a fault vaccine according to the historical fault sample set and the fault vaccine in the start-up procedure comprises: calculating a first deviation matrix according to the second normal start-up sample set and the second fault start-up sample set; calculating a second deviation matrix according to the normal vaccine and the fault vaccine; calculating the second immune coefficient according to the first deviation matrix and the second deviation matrix.

In some embodiments, obtaining a second immune coefficient of a fault vaccine according to the historical fault sample set and the fault vaccine in the steady-state operation procedure comprises: calculating a third deviation matrix according to the second fault steady-state sample set; calculating a fourth deviation matrix according to the fault vaccine; calculating the second immune coefficient according to the third deviation matrix and the fourth deviation matrix.

In some embodiments, the first obtaining unit comprises: a first obtaining sub-unit, configured to obtain a second set of data in an operating condition the same as a current operating condition from the second normal start-up sample set and calculating a fifth deviation matrix to obtain the diagnosing antigen according to the detecting antigen and the second set of data if the fault occurs in the second start-up procedure; a second obtaining sub-unit, configured to obtain the diagnosing antigen by subtracting operation data at a time when the fault is determined from each online operation data in the detecting antigen if the first fault occurs in the second steady-state operation procedure.

In some embodiments, the apparatus further comprises: a first updating module, configured to update the normal antibody database through online operation data according to a comparison of the detecting antigen and the normal antibody database; a second updating module, configured to update the plurality of fault antibody databases through the online operation data according respectively to a plurality of comparisons of the diagnosing antigen and the plurality of fault antibody databases.

With the fault diagnosis method and apparatus according to embodiments of the present disclosure, the problem that there is a lack of historical data of a diagnostic object may be overcome, a production equipment or a technological process similar to the diagnostic object may be defined as a transplant provider of the vaccine transplantation, original antibodies of an artificial immune system of the diagnostic object may be generated with normal data and fault data in the historical data of the transplant provider, and a fault diagnosis of the diagnostic object may be performed based on the artificial immune system. With a method of generating an antigen, an antibody, an antigen database and an antibody database provided in the present disclosure, the original antibodies may be generated by using historical data of other equipments in a fault diagnosis process and massive diverse antibodies may be generated by a cloning technique or a variation process. Antibodies may be updated automatically in the fault diagnosis process and a requirement for the adaptability of a technological process may be satisfied, such that a fault occurring in the technological process may be discovered accurately and quickly and a type of the fault may be determined.

A computer readable storage medium is provided. The computer readable storage medium comprises a computer program for executing the fault diagnosis method according to the first aspect of the present disclosure, when running on a computer. With the fault diagnosis method, the problem that there is a lack of historical data of a diagnostic object may be overcome, a production equipment or a technological process similar to the diagnostic object may be defined as a transplant provider of the vaccine transplantation, original antibodies of an artificial immune system of the diagnostic object may be generated with normal data and fault data in the historical data of the transplant provider, and a fault diagnosis of the diagnostic object may be performed based on the artificial immune system. With a method of generating an antigen, an antibody, an antigen database and an antibody database provided in the present disclosure, the original antibodies may be generated by using historical data of other equipments in a fault diagnosis process and massive diverse antibodies may be generated by a cloning technique or a variation process. Antibodies may be updated automatically in the fault diagnosis process and a requirement for the adaptability of a technological process may be satisfied, such that a fault occurring in the technological process may be discovered accurately and quickly and a type of the fault may be determined.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart of a fault diagnosis method according to an embodiment of the present disclosure.

FIG. 2 is a detailed flow chart of a fault diagnosis method according to an embodiment of the present disclosure.

FIG. 3 is a schematic diagram of a structure of an antigen/antibody in a fault diagnosis method according to an embodiment of the present disclosure.

FIG. 4 is a schematic diagram illustrating a technological process of a rectifying tower system using a fault diagnosis method according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. In contrast, the present disclosure may include alternatives, modifications and equivalents within the spirit and scope of the appended claims. The same or similar elements and the elements having same or similar functions are denoted by like reference numerals throughout the descriptions. A plurality of particular details are illustrated for providing a comprehensive understanding of the subject matter proposed herein. However, it would be understood by those skilled in the art that the subject matter proposed herein may be implemented without using these particular details. In other cases, well-known methods, programs, components and circuits are not described in detail, thus avoiding the unnecessary obscuring of aspects of embodiments.

Although terms such as “first” and “second” are used herein for describing various elements, these elements should not be limited by these terms. These terms are only used for distinguishing one element from another element. For example, a first sequencing criterion may also be called a second sequencing criterion, and similarly, the second sequencing criterion may also be called the first sequencing criterion, without departing from the scope of the present disclosure. The first sequencing criterion and the second sequencing criterion are both a sequencing criterion, but are not the same sequencing criterion.

Terms used herein in the description of the present disclosure are only for the purpose of describing specific embodiments, but should not be construed to limit the present disclosure. As used in the description of the present disclosure and the appended claims, “a” and “the” in singular forms mean including plural forms, unless clearly indicated in the context otherwise. It should also be understood that, as used herein, the term “and/or” represents and contains any one and all possible combinations of one or more associated listed items. It should be further understood that, when used in the specification, terms “comprising” and/or “containing” specify the presence of stated features, operations, elements and/or components, but do not exclude the presence or addition of one or more other features, operations, elements, components and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The fault diagnosis method according to an embodiment of the present disclosure will be described with reference to drawings.

A technological process in embodiments of the present disclosure includes but is not limited to a chemical process, a refining process or a biological pharmaceutical process .etc. With the fault diagnosis method according to embodiments of the present disclosure, a fault occurring in the above-mentioned technological process may be discovered accurately and quickly and a type of the fault also may be determined.

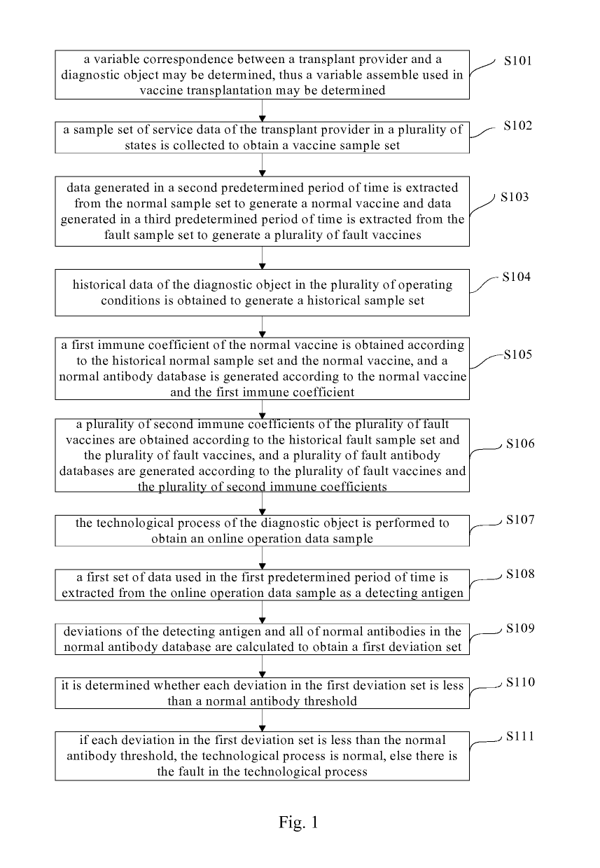

Specifically, referring to FIG. 1, the fault diagnosis method includes following steps.

At step S101, a variable correspondence between a transplant provider and a diagnostic object may be determined according to process information, operating regulations and existing historical data of the diagnostic object and the transplant provider. That is, a measured variable assemble used in vaccine transplantation may be determined. The process information includes, but is not limited to, technological process sheets, material status, operating parameters, parameters of controllers and environmental parameters.

At step S102, a sample set of operation data of the transplant provider in a plurality of operating conditions is obtained (i.e. collected). The sample set is a vaccine sample set. The vaccine sample set includes a normal vaccine sample set (i.e. a normal sample set) and a fault vaccine sample set (i.e. a fault sample set), the normal vaccine sample set includes a first normal start-up sample set comprising normal data in a first start-up procedure of the transplant provider and a first normal steady-state sample set comprising normal data in a first steady-state operation procedure of the transplant provider, and the fault vaccine sample set includes a first fault start-up sample set comprising fault data of a plurality of types of faults occurring in the first start-up procedure and a first fault steady-state sample set comprising fault data of the plurality of types of faults occurring in the first steady-state operation procedure.

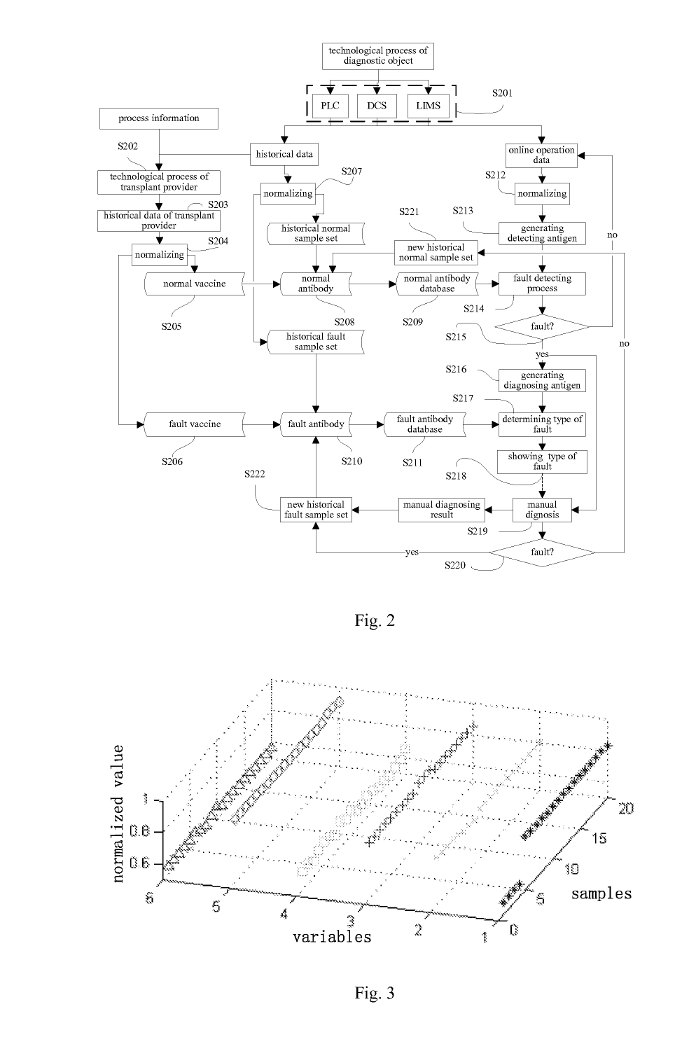

It should be noted that, the operation data of the transplant provider needs to be normalized before the sample set is obtained. Specifically, as shown in FIG. 2, in step S204, the operation data of the transplant provider generated in step S203 is normalized to obtain the sample set according to the follow formula:

$$X = 0.5 + \frac{x - \overline{X}}{{X}_{max} - {X}_{min}} ,$$

in which x is the operation data corresponding to a variable, X̅ is an average value of the historical data corresponding to the variable of the transplant provider in a normal operating condition, Xₘₐₓ is a maximum value of the historical data corresponding to the variable of the transplant provider in the normal operating condition, and Xₘᵢₙ is a minimum value of the historical data corresponding to the variable of the transplant provider in the normal operating condition.

At step S103, data in a second predetermined period of time is extracted from the normal sample set to generate a normal vaccine and data in a third predetermined period of time is extracted from the fault sample set to generate a plurality of fault vaccines corresponding respectively to the plurality of types of faults. For an example, the normal vaccine may be obtained according to the normal sample set which is obtained through step S204 of normalizing the operation data of the transplant provider. Specifically, referring to FIG. 2, in step S205, the technological process of the transplant provider includes the first start-up procedure and the first steady-state operation procedure. Data in the second predetermined period of time (such as a time series with a fixed length in the first start-up procedure and/or a time series with a fixed length in the first steady-state operation procedure) is extracted from the normal sample set to generate the normal vaccine of the first start-up procedure and/or the first steady-state operation procedure. The normal vaccine is denoted as V_{N}=[V_{N1}, V_{N2}, . . . , V_{Nn}], in which V_{Ni} is a normal sample corresponding to variable i, n is a number of the variables in the measured variable assemble.

Similarly, the plurality of fault vaccines corresponding respectively to the plurality of types of faults may be obtained according to the fault sample set which is obtained through step S204 of normalizing the operation data of the transplant provider. Specifically, referring to FIG. 2, in step S206, Data in the first predetermined period of time is extracted from the fault sample set to generate the plurality of fault vaccines corresponding respectively to the plurality of types of faults. The fault vaccine is denoted as V_{S}=[V_{S1}, V_{S2}, . . . , V_{Sn}], V_{Si} is a fault sample corresponding to variable i.

At step S104, historical data of the diagnostic object in the plurality of operating conditions is obtained to generate a historical sample set, the historical sample set includes a historical normal sample set and a historical fault sample set. The historical sample set may be obtained by using the DCS of the diagnostic object. Referring to FIG. 2, as shown in step S201, the historical data of the diagnostic object in the plurality of operating conditions is obtained to generate the historical sample set. The historical sample set includes the historical normal sample set and the historical fault sample set. The historical normal sample set includes a second normal start-up sample set comprising normal data in a second start-up procedure of the diagnostic object and a second normal steady-state sample set comprising normal data in a second steady-state operation procedure of the diagnostic object, and the historical fault sample set includes a second fault start-up sample set comprising fault data of the plurality of types of faults occurring in the second start-up procedure and a second fault steady sample set comprising fault data of the plurality of types of faults in the second steady-state operation procedure. Referring to FIG. 2, in step S207, data in the historical sample set may be normalized according to the follow formula:

$$Y = 0.5 + \frac{y - \overline{Y}}{{Y}_{max} - {Y}_{min}} ,$$

in which y is data corresponding to the variable in the historical sample set, Y̅ is an average value of the historical data corresponding to the variable of the diagnostic object in the normal operating condition, Xₘₐₓ is a maximum value of the historical data corresponding to the variable of the diagnostic object in the normal operating condition, and Xₘᵢₙ is a minimum value of the historical data corresponding to the variable of the diagnostic object in the normal operating condition.

At step S105, a first immune coefficient of the normal vaccine is obtained according to the historical normal sample set and the normal vaccine, and a normal antibody database is generated according to the normal vaccine and the first immune coefficient. Specifically, referring to FIG. 2, in step S208, for the historical normal sample set (the second normal start-up sample set or the second normal steady-state sample set), normal vaccine samples in an operating condition the same as an operating condition (such as operational parameters, environmental parameters and material statuses) in which the normal samples in the historical normal sample set H=[H₁, H₂, . . . , Hₙ] are used are extracted from the normal vaccine to generate a first normal vaccine sample set V=[V₁, V₂, . . . , Vₙ]. The first immune coefficient of the normal vaccine may be calculated according to formula (1) to represent a correspondence between the historical normal sample set and the normal vaccine.

Rt=[Rt₁,Rt₂, . . . ,Rtₙ]=[|H₁|/|V₁|,|H₂|/|V₂|, . . . ,|Hₙ|/|Vₙ|] (1)

Two samples are selected from the normal vaccine randomly to generate the normal antibody according to formula (2), thus a plurality of normal antibodies may be obtained.

Abₙₒᵣₘₐₗ=Rt(aX_{c}+b(X_{c}−X_{d})) (2)

in which Abₙₒᵣₘₐₗ is the normal antibody, a is a random decimal within 0.5 to 2, b is a random decimal within −1 to 1. Xc and Xd are the two different samples in a same type originating from the normal sample set (the first normal start-up sample set or the first normal steady-state sample set).

The normal antibody database includes a normal start-up antibody database corresponding to the first start-up procedure and/or a normal steady-state antibody database corresponding to the first steady-state operation procedure. The normal start-up antibody database is used in the second start-up procedure to detect a fault, and the steady-state antibody database is used in the second steady-state operation procedure to detect a fault.

At step S106, a plurality of second immune coefficients of the plurality of fault vaccines are obtained according to the historical fault sample set and the plurality of fault vaccines, and a plurality of fault antibody databases are generated according to the plurality of fault vaccines and the plurality of second immune coefficients. Specifically, referring to FIG. 2, in step S210, for the historical fault sample set (the second fault start-up sample set or the second fault steady-state sample set), fault vaccine samples in an operating condition the same as an operating condition (such as operational parameters, environmental parameters, material statuses, a type of a fault, an occurring time and an amplitude of a fault) in which fault samples in the historical fault sample set H_{F}^{n×m} are used are extracted from the fault vaccine to generate a first fault vaccine sample set V_{F}^{n×m}, n is the number of the variables in the measured variable assemble and m is a number of the fault samples in the historical fault sample set.

In the second start-up procedure, the historical fault sample set H_{F}^{n×m} may be the second fault start-up sample set.

Normal samples in an operating condition the same as an operating condition (such as operational parameters, environmental parameters, material statuses and start-up time) in which the fault samples in H_{F}^{n×m} are used are extracted from the second normal start-up sample set to generate a second historical normal start-up sample set H_{N}^{n×l}, l is a number of the normal samples in H_{N}^{n×l}. A first deviation matrix of the second fault start-up sample set H_{F}^{n×m} and the second historical normal start-up sample set H_{N}^{n×l} may be obtained by using a DTW (Dynamic Time Warping) algorithm. In other embodiments of the present disclosure, the first deviation matrix may be calculated according to formula (3).

φ_{H}^{n×m}=[H_{F}(1)−H_{N}(k);H_{F}(2)−H_{N}(k+1); . . . ,H_{F}(m)−H_{N}(k+m−1)] (3)

A deviation of a first sample in the second fault start-up sample set H_{F}^{n×m} and a k^{th} sample in the second historical normal start-up sample set H_{N}^{n×l} is a minimum deviation.

Normal vaccine samples in an operating condition the same as an operating condition (such as operational parameters, environmental parameters, material statuses and start-up time) in which the fault vaccine samples in V_{F}^{n×m} are used are extracted from the normal vaccine to generate a first normal vaccine sample set V_{N}^{n×l}, l is a number of the normal vaccine samples in V_{N}^{n×l}. A second deviation matrix of the first fault vaccine sample set V_{F}^{n×m} and the first normal vaccine sample set V_{N}^{n×l} may be obtained by using the DTW algorithm. In other embodiments of the present disclosure, the first deviation matrix may be calculated according to formula (4).

φ_{V}^{n×m}=[V_{F}(1)−V_{N}(k);V_{F}(2)−V_{N}(k+1); . . . ,V_{F}(m)−V_{N}(k+m−1)] (4)

A deviation of a first sample in the first fault vaccine sample set V_{F}^{n×m} and a k^{th} sample in the first normal vaccine sample set V_{N}^{n×l} is a minimum deviation.

The first deviation matrix may represent deviations of normal data and fault data used in the second start-up procedure. The second deviation matrix may represent deviations of normal data and fault data used in the first start-up procedure.

In the steady-state operation procedure, the historical fault sample set H_{F}^{n×m} may be the second fault steady-state sample set.

A third deviation matrix may be obtained by subtracting a first sample in the second fault steady-state sample set H_{F}^{n×m} from each sample in the second fault steady-state sample set H_{F}^{n×m} according to formula (5).

φ_{H}^{n×m}=[H_{F}(1)−H_{F}(1);H_{F}(2)−H_{F}(1); . . . ,H_{F}(m)−H_{F}(1)] (5)

A fourth deviation matrix may be obtained by subtracting a first sample in the first fault vaccine sample set V_{F}^{n×m} from each sample in the first fault vaccine sample set V_{F}^{n×m} according to formula (6).

φ_{V}^{n×m}=[V_{F}(1)−V_{F}(1);V_{F}(2)−V_{F}(1); . . . ,V_{F}(m)−V_{F}(1)] (6)

After obtaining the first deviation matrix, the second deviation matrix, the third deviation matrix and the fourth deviation matrix, the plurality of second immune coefficients of the plurality of fault vaccines may be obtained according to formula (7), each of the plurality of second immune coefficients represents a correspondence between the historical fault sample set and a fault vaccine.

Rt=[Rt₁,Rt₂, . . . ,Rtₙ]=[|φ_{H1}|/|φ_{V1}|,|φ_{Hn}|/|φ_{Vn}|, . . . ,|φ_{Hn}|/|φ_{Vn}|] (7)

Two samples are selected from each of the plurality of fault vaccines randomly to generate a fault antibody according to formula (8), thus a plurality of fault antibodies may be obtained.

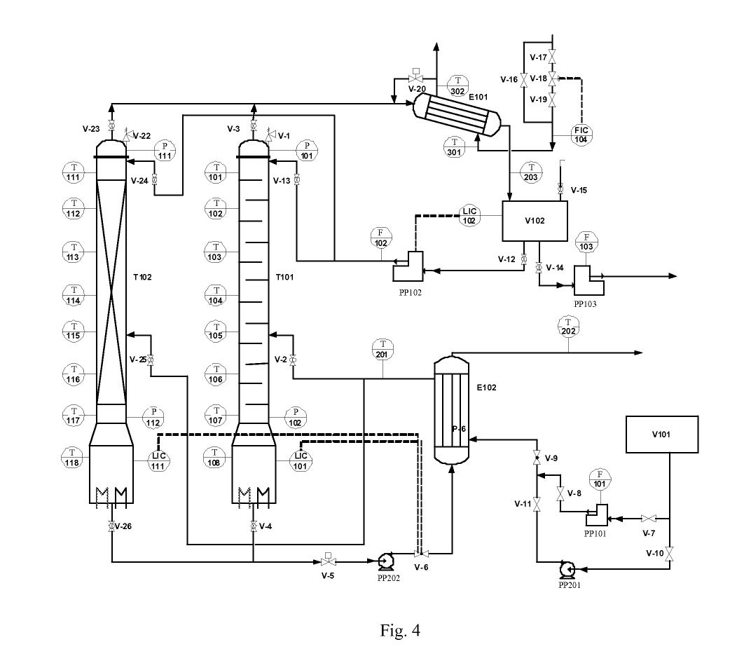

Ab_{fault}=Rt(aφ_{c}+b(φ_{c}−φ_{d})) (8)

in which Ab_{fault} is the fault antibody, a is a random decimal within 0.5 to 2, b is a random decimal within −1 to 1. φ_{c} and φ_{d} are the two samples in a same type originating from the fault sample set (the first fault start-up sample set or the first fault steady-state sample set). Rt is the second immune coefficient. If there is no fault sample corresponding to a type of fault in the historical fault sample set, a corresponding immune coefficient of a fault vaccine corresponding to the type of fault is configured as 1 (i.e. Rt=1). Referring to FIG. 3, variables v-1 to v-6 are deviations corresponding respectively to six variables used in an equipment generation process.

In an embodiment, after obtaining the plurality of normal antibodies and the plurality of fault antibodies, the normal antibody database may be obtained by storing normal antibodies in the normal antibody database and the plurality of fault antibody databases may be obtained by storing fault antibodies with the same type in a fault antibody database to obtain the plurality of fault antibody databases. And then, a normal antibody database threshold may be obtained by the DTW algorithm or a deviation computational formula and a plurality of fault antibody thresholds corresponding respectively to the plurality of fault antibody databases may be obtained by the DTW algorithm or the deviation computational formula.

Specifically, referring to FIG. 2, in step S209 and step S211, the plurality of normal antibodies are stored in the normal antibody database (including a normal start-up antibody database and a normal steady-state antibody database), and the plurality of fault antibodies are stored in the plurality of fault antibody databases corresponding respectively to the plurality types of faults. If a type of fault occurs both in the first start-up procedure and the first steady-state operation procedure, there are two fault antibody databases (a fault start-up antibody database and a fault steady-state antibody database) corresponding to the type of fault. A deviation of each two antibodies in an antibody database (a normal antibody database or a fault antibody database) may be calculated by using the DTW algorithm. In some embodiments, the deviation of each two antibodies in the antibody database may be calculated by using formula (9).

$$η = \frac{{min}_{1 \leq k \leq m - n} ( {\sum }_{i = k}^{n + k - 1} \vert Ab ( k ) - Ag ( i ) \vert )}{n} \qquad ( 9 )$$

in which Ab is a longer antibody (an antibody corresponding to more samples), m is a length of Ab, i.e. a number of samples in Ab, Ag is a shorter antibody (an antibody corresponding to less samples), n is a length of Ag, i.e. a number of samples in Ag.

The deviation of each two antibodies in the antibody database may be defined as ηₖ (i, j) (a deviation of a i^{th} antibody and a j^{th} antibody in a k^{th} antibody database), an antibody threshold of the antibody database may be calculated according to formula (10).

$${threshold}_{k} = {max}_{1 \leq i \leq n} {min}_{1 \leq j \leq n , i \neq j} \vert {η}_{k} ( i , j ) \vert \qquad ( 10 )$$

After obtaining the normal antibody database, the plurality of fault antibody databases, the normal antibody database threshold and the plurality of fault antibody thresholds, online operation data of a technological process of the diagnostic object may be obtained to determine whether there is a fault in the technological process of the diagnostic object and to determine a type of the fault if there is the fault. The online operation data may be obtained by following steps.

At step S107, the technological process of the diagnostic object is performed to obtain an online operation data sample.

At step S108, a first set of data used in the first predetermined period of time is extracted from the online operation data sample as a detecting antigen. Further, data in the online operation data sample is normalized. Specifically, referring to FIG. 2, online operation data is obtained after step S212 of normalizing the data in the online operation data sample. In step S213, the first set of data in the first predetermined period of time is defined as C^{n×m}=[C₁, C₂, . . . , Cₙ], Cᵢ is online operation data corresponding to variable i in the first predetermined period of time, n is the number of variables in the measured variable assemble and m is a number of online operation data samples in the first set of data. In a fault detecting process, the first set of data in the first predetermined period of time may be the detecting antigen, i.e. Ag=C. In embodiments of the present disclosure, the first predetermined period of time is determined by rule of thumb.

After the detecting antigen is generated, the fault detecting process is performed through step S214 of calculating deviations of the detecting antigen and all of normal antibodies in the normal antibody database to obtain a first deviation set. If each deviation in the first deviation set is less than the normal antibody threshold, the technological process is normal, else there is a fault in the technological process. Specifically, the fault detecting process in step S214 includes following steps.

At step S109, deviations of the detecting antigen and all of normal antibodies in the normal antibody database are calculated to obtain a first deviation set.

At step S110, it is determined whether each deviation in the first deviation set is less than a normal antibody threshold.

At step S111, if each deviation in the first deviation set is less than the normal antibody threshold, the technological process is normal, else there is the fault in the technological process.

In the fault detecting process, if the technological process is in the second start-up procedure, the normal antibody database is the normal start-up antibody database; else if the technological process is in the second steady-state operation procedure, the normal antibody database is the normal steady-state antibody database.

In an embodiment, after step S214, step 215 is followed to determine a detecting result obtained in step 214, if the detecting result is normal, a message indicating everything is normal is showed in a user interface.

Further, if there is the fault in the technological process, a type of the fault is determined. A diagnosing antigen is generated to determine the type of the fault according to the plurality of fault antibody thresholds. Specifically, a step of determining the type of the second fault comprises following steps.

1. A first sample in the detecting antigen is defined as D^{n×l}=[D₁, D₂, . . . , Dₙ]. Referring to FIG. 2, in step S216, if the fault occurs in the second start-up procedure, normal samples used in a n operating condition the same as a current operating condition (such as operational parameters, environmental parameters, material statuses and start-up time) are extracted from the second normal start-up sample set to generate a second set of data H′_{N}^{n×l}, and then a fifth deviation matrix is calculated to obtain the diagnosing antigen by using the DTW algorithm or a first predetermined formula (formula (11)).

Ag=[C(1)−H_{N}(k);C(2)−H_{N}(k+1); . . . ,C(m)−H_{N}(k+m−1)] (11)

A deviation of the first sample in the detecting antigen and a k^{th} data in the second set of data H′_{N}^{n×l} is a minimum deviation.

If the fault occurs in the second steady-state operation procedure, the diagnosing antigen may be obtained by subtracting the first sample in the detecting antigen from each sample in the detecting antigen, i.e. Ag=[Ag₁, Ag₂, . . . , Agₙ]=[C₁−D₁, C₂−D₂, . . . , Cₙ−Dₙ], Agᵢ is a deviation between variable i used in the current operating condition and variable i used in the normal operating condition. It should be noted that, the diagnosing antigen and the antibody have a same format, which are both matrixes consisting of samples based on time series.

2. After the diagnosing antigen is generated, step S217 is followed to calculate deviations of the diagnosing antigen and all of fault antibodies in the plurality of fault antibody databases to obtain a second deviation set. A deviation of the diagnosing antigen and a fault antibody from a fault antibody database is compared with a fault antibody threshold corresponding to the fault antibody database.

3. If the deviation of the diagnosing antigen and the fault antibody from the fault antibody database is less than the fault antibody threshold corresponding to the fault antibody database, the fault is a type of fault corresponding to the fault antibody.

In an embodiment, after step S217 of determining the type of the fault, step S218 is followed to show the type of the fault in the user interface for the operator, such that the operator may repair the technological process according to the type of the fault. An artificial diagnosis may be performed by the operator (step S219) and the type of fault may be selected in the user interface with reference to a diagnosing result obtained in step S218. Additional, information may be input in the user interface, if the type of the fault is not determined or the diagnosing result is not correct, the operator may input the type of the fault to correct.

After the artificial diagnosis, the antibody database (the normal antibody database or a fault antibody database) may be updated through online operation data according to a comparison of the detecting antigen and the antibody database. Specifically, an artificial diagnosing result obtained in step S219 may be determined in step S220. If the artificial diagnosing result shows that everything is normal, step S221 is followed to generate new historical normal sample set according to online operation data used in a period of time from a time when the fault is determined to a current time, else step S222 is followed to generate new historical fault sample set according to the online operation data used in a period of time from a time when the fault is determined to a current time.

As shown in FIG. 4, FIG. 4 is a schematic diagram illustrating a technological process of a rectifying tower system using a fault diagnosis method according to an embodiment of the present disclosure.

Referring to FIG. 4, in the embodiment, an experimental device includes a sieve-plate tower and a packing tower. The sieve-plate tower includes fifteen tower plates and a feed port at the twelfth tower plate. The sieve-plate tower has a height of 2.2 meter and a tower diameter of 7.5 meter. The packing tower has a height the same as that of the sieve-plate tower and a tower diameter the same as that of the sieve-plate tower. The packing tower has a feed port whose height is the same as that of the feed port of the sieve-plate tower. The rectifying tower system is configured for separating alcohol and water. The sieve-plate tower and the packing tower may be switched according to a requirement of an experiment. A DCS is configured to ensure that the rectifying tower system is operated steadily and safety and to collect data for a fault diagnosis. There are thirty three measured variables in the rectifying tower system which may be obtained by the DCS for the fault diagnosis. There are twelve measured variables only belonging to the sieve-plate tower and twelve measured variables only belonging to the packing tower and nine measured variables both belonging to the sieve-plate tower and the packing tower. The measured variables includes twenty one temperatures (including tower plate temperatures T101-T108 of the sieve-plate tower, tower plate temperatures T111-T118 of the packing tower, a feed temperature T201, a temperature T202 of a tower kettle outlet, a temperature T203 of a reflux accumulator inlet, a temperature T301 of a condensate water inlet and a temperature T302 of a condensate water outlet), four pressures (including a tower top pressure P101 of the sieve-plate tower, a pressure P102 of a first tower kettle of the sieve-plate tower, a tower top pressure P111 of the packing tower, a pressure P112 of a second tower kettle of the packing tower), four flows (including a feed flow F101, a quantity of reflux F102, a produced quantity F103 of products from a tower top and a flow F104 of the condensate water) and four levels (including a level L101 of the first tower kettle, a level L102 of a first reflux accumulator of the sieve-plate tower, a level L103 of the second tower kettle, a level L104 of a second reflux accumulator of the packing tower).

In this embodiment, there are two PID controllers LIC101 and LIC102 used in a technological process of the sieve-plate tower. LIC101 is configured to change a frequency of a tower kettle pump to control level L101 of the first tower kettle. LIC102 is configured to change quantity of reflux F102 of a reflux metering pump PP 102 to control level L102 of the first reflux accumulator V102.

Before the start-up procedure, condensate water valves V17, V19 and air release valve V15 are switched on and other valves are switched off. Take the sieve-plate tower as an example, operating steps of the start-up procedure of the sieve-plate tower include following steps, which are similar to operating steps of the start-up procedure of the packing tower.

1. Valves V2, V3, V9, V10 and V11 are switched on, and solution (3:7 ratio of alcohol to water) is imported to the first tower kettle by speed charging pump PP201 in a normal pressure and temperature.

2. When the level of the first tower kettle is higher than 27.5 cm, speed charging pump PP201 and values V10 and V11 are switched off, the first tower kettle is heated, a heating load of the first tower kettle is configured as 100%, a condensate water control is switched to manual and opening of valve V18 is adjusted to ensure that a flow through valve V18 is greater than 300 L/h.

3. When tower plate temperature T102 reaches 70° C., the heating load of the first tower kettle is reduced to 60%, valves V12 and V13 are switched on, controller LIC102 is switched to automatic, and SV of controller LIC102 is configured as 4 cm.

4. When the level of the first reflux accumulator is stable, valves V4, V5, V6, V7 and V8 are switched on, a feed metering pump is turned on, a feed flow of the feed metering pump is configured as 10 L/h, controller LIC101 is switched to automatic, and SV of controller LIC101 is configured as 25 cm.

5. When the level of the first tower kettle is stable, valve V14 is switched on, a product metering pump is switched on, a reflux ratio controller is started and a reflux ratio is configured as 2.

After the start-up procedure of the sieve-plate tower is finished, the technological process is in a steady-state operation procedure, operating parameters and controlling parameters in the steady-state operation procedure are shown in table 1. Table 1 illustrates parameters in a normal operating condition.

TABLE 1

| | parameter | symbol | value | unit |
|---|---|---|---|---|
| operating | heating power of the | W | 15.0 ± 0.5 | kw |
| parameter | first tower kettle | | | |
| | on-steam pressure | P101 | 1 | atm |
| | alcohol concentration | C1 | 30 ± 1 | v/v % |
| | in the solution | | | |
| | feed flow | F101 | 10.0 | L/h |
| | condensate water flow | F104 | 320.0 ± 10 | L/h |
| | reflux ratio | R | 0.5, 1, 2, 4 | 1 |
| controlling | level of the first | L101 | 35 | cm |
| parameter | tower kettle | | | |
| | level of the first | L102 | 4 | cm |
| | reflux accumulator | | | |

Take a fault diagnosis of the sieve-plate tower performed by generating vaccines according to data of the packing tower (the packing tower is the transplant provider and the sieve-plate tower is the diagnostic object) as an example, a detailed description of the fault diagnosis is described.

Referring to FIG. 2, if a fault detecting process is requested to be performed on the rectifying tower system, historical data of the variables in the rectifying tower system is obtained at secondly intervals by DCS through step S201. In other embodiments of the present disclosure, the historical data may be obtained by other systems, such as a system directly connected to a production equipment. In step S201, the historical data is obtained by a PLC (Programmable Logic Controller) and a LIMS (Laboratory Information Management System).

In step S202, a first normal start-up sample set, a first normal steady-state sample set, a first fault start-up sample set and a first fault steady-state sample set are obtained according to the historical data of the packing tower.

After step S204 of normalizing the first normal start-up sample set, the first normal steady-state sample set, the first fault start-up sample set and the first fault steady-state sample set, in step S205, a first normal vaccine is generated according to fifty segments of start-up data with a length of 2000 s selected from the first normal start-up sample set, and a second normal vaccine is generated according to fifty segments of steady-state data with a length of 60 s selected from the first normal steady-state sample set. In step S208, a historical normal sample set is obtained after step S207 of normalizing a segment of start-up data with a length of 2000 s selected from historical normal data used in the start-up procedure of the sieve-plate tower and a segment of steady-state data with a length of 60 s selected from historical normal data used in the steady-state operation procedure of the sieve-plate tower. A first normal immune coefficient of the first normal vaccine and a second normal immune coefficient of the second normal vaccine are calculated. And then normal antibodies are generated according to the first normal vaccine, the first normal immune coefficient, the second normal vaccine and the second normal immune coefficient. In step S209, each of the normal antibodies is stored in a normal start-up antibody database or a normal steady-state antibody database. And then, a first normal antibody threshold of the normal start-up antibody database and a second normal antibody threshold of the normal steady-state antibody database are calculated.

Additional, assuming that the first fault start-up sample set includes a first type of fault start-up sample set corresponding to a first type of fault that the first tower kettle is not heated in the start-up procedure of the packing tower and a second type of fault preparation sample set corresponding to a second type of fault that the condensate water flow is thinning in the start-up procedure of the packing tower, the first fault steady-state sample set includes a third type of fault steady-state sample set corresponding to a third type of fault that an outlet valve at the packing tower top is switched off in the steady-state operation procedure of the packing tower and a fourth type of fault steady-state sample set corresponding to a fourth type of fault that heat of the first tower kettle is too large in the steady-state operation procedure of the packing tower.

After step S204 of normalizing the first normal start-up sample set, the first normal steady-state sample set, the first fault start-up sample set and the first fault steady-state sample set, in step S206, a first fault vaccine is generated according to a segment of start-up data with a length of 60 s selected from the first type of fault start-up sample set, a second fault vaccine is generated according to a segment of start-up data with a length of 60 s selected from the second type of fault start-up sample set, a third fault vaccine is generated according to a segment of steady-state data with a length of 60 s selected from the third type of fault steady-state sample set, and a fourth fault vaccine is generated according to a segment of steady-state data with a length of 60 s selected from the fourth type of fault steady-state sample set. In step S210, a historical fault sample set is obtained after step S207 of normalizing a segment of start-up data with a length of 60 s selected from historical fault data corresponding to the first type of fault used in the start-up procedure of the sieve-plate tower and a segment of steady-state data with a length of 60 s selected from historical fault data corresponding to the third type of fault used in the steady-state operation procedure of the sieve-plate tower. A first fault immune coefficient of the first fault vaccine and a third fault immune coefficient of the third fault vaccine are calculated. Since there is no historical fault data corresponding to the second type of fault and the fourth type of fault, a second fault immune coefficient of the second fault vaccine is land a fourth fault immune coefficient of the fourth fault vaccine is 1. And then fault antibodies are generated according to the first fault vaccine, the first fault immune coefficient, the second fault vaccine, the second fault immune coefficient, the third fault vaccine, the third fault immune coefficient, the fourth fault vaccine and the fourth fault immune coefficient. In step S211, each of the fault antibodies is stored in one of a first fault antibody database corresponding to the first type of fault, a second fault antibody database corresponding to the second type of fault, a third fault antibody database corresponding to the third type of fault and a fourth fault antibody database corresponding to the fourth type of fault. And then a first fault antibody threshold of the first fault antibody database, a second fault antibody threshold of the second fault antibody database, a third fault antibody threshold of the third fault antibody database, and a fourth fault antibody threshold of the fourth fault antibody database are calculated.

Then, a fault detecting process and a fault diagnosis process may be performed after normalizing online operation data of the sieve-plate tower. In this embodiment, there are four sample sets of online operation data.

Take a first sample set as an example, online operation data in the first sample set are in a first period of time in the start-up procedure of the sieve-plate tower in a normal operating condition. After step S212, a first detecting antigen corresponding to time t1 is generated in step S213 according to a segment of online operation data in a second period of time (such as from 10 seconds earlier than time t1 to time t1) selected from the first sample set. And then, step S214 is followed to perform the fault detecting process. Deviations of the first detecting antigen and all of normal antibodies in the normal start-up antibody database are calculated to obtain a first temporary deviation set. If each deviation in the first temporary deviation set is less than the first normal antibody threshold, there is no fault occurring in the second period of time. Thus, it may be determined that there is no fault occurring in the first period of time according to the first sample set. After obtaining a detecting result in step S215, a message indicating everything is normal may be shown in the user interface.

Take a third sample set as an example, online operation data in the third sample set are in a third period of time. Assuming that the third period of time is from the 900^{th} second to the 1200^{th} second in the start-up procedure of the sieve-plate tower and a first type of fault occurs at the 990^{th} second. After step S212, a third detecting antigen corresponding to time t3 is generated in step S213 according to a segment of online operation data in a fourth period of time (such as from 10 seconds earlier than time t3 to time t3) selected from the third sample set. And then, step S214 is followed to perform the fault detecting process. Deviations of the third detecting antigen and all of normal antibodies in the normal start-up antibody database are calculated to obtain a third temporary deviation set. It is discovered that if time t3 is earlier than the 990^{th} second, each deviation in the third temporary deviation set is less than the first normal antibody threshold, that is, there is no fault, at this time, after obtaining a detecting result in step S215, a message indicating everything is normal may be shown in the user interface. When time t3 is later than the 1012^{th} second, each deviation in the third temporary deviation set is greater than the first normal antibody threshold, that is, there is a third fault. At this time, after obtaining a detecting result in step S215, step S216 is followed. A first diagnosing antigen is calculated according to the segment of online operation data in the fourth period of time and the historical normal sample set. And then, step S217 is followed to determine a type of the third fault. Deviations of the first diagnosing antigen and all of fault antibodies in the first fault antibody database, the second fault antibody database, the third fault antibody database and the fourth fault antibody database are calculated to obtain a fourth temporary deviation set. It is discovered that a deviation of the first diagnosing antigen and a fault antibody in the first fault antibody database is less than the first fault antibody threshold, deviations of the first diagnosing antigen and fault antibodies in the second fault antibody database are greater than the second fault antibody threshold, deviations of the first diagnosing antigen and fault antibodies in the third fault antibody database are greater than the third fault antibody threshold and deviations of the first diagnosing antigen and fault antibodies in the fourth fault antibody database are greater than the fourth fault antibody threshold. Thus a message indicating that there is a first type of fault is shown in the user interface. In step S219, a manual diagnosing result is generated, indicating that a first type of fault occurs. In step S220, the type of third fault may be selected and confirmed. And then, in step S223, the historical fault sample set is updated according to online operation data in a fifth period of time (from 10 seconds earlier than a time when the third fault is detected to a current time) and the first fault immune coefficient is updated. And then, the first fault antibody database, the second fault antibody database, the third fault antibody database and the fourth fault antibody database are updated and the first fault antibody threshold, the second fault antibody threshold, the third fault antibody threshold and the fourth fault antibody threshold are calculated.

Take a fifth sample set as an example, online operation data in the fifth sample set are used in a sixth period of time. Assuming that the sixth period of time is from the 1900^{th} second to the 2200^{th} second in the steady-state operation procedure of the sieve-plate tower and a third type of fault occurs at the 1932^{th} second. After step S212, a fifth detecting antigen corresponding to time t5 is generated in step S213 according to a segment of online operation data in a seventh period of time (such as from 10 seconds earlier than time t5 to time t5) selected from the fifth sample set. And then, step S214 is followed to perform the fault detecting process. Deviations of the fifth detecting antigen and all of normal antibodies in the normal steady-state antibody database are calculated to obtain a fifth temporary deviation set. It is discovered that if time t5 is earlier than the 1932^{th} second, each deviation in the fifth temporary deviation set is less than the second normal antibody threshold, that is, there is no fault, at this time, after obtaining a detecting result in step S215, a message indicating everything is normal may be shown in the user interface. When time t5 is later than the 1932^{th} second, each deviation in the fifth temporary deviation set is greater than the second normal antibody threshold, that is, there is a fifth fault. At this time, after obtaining a detecting result in step S215, step S216 is followed. A second diagnosing antigen is generated by calculating deviations between the segment of online operation data in the seventh period of time and online operation data at a time when is 10 seconds earlier than time t5. And then, step S217 is followed to determine a type of the fifth fault. Deviations of the second diagnosing antigen and all of fault antibodies in the first fault antibody database, the second fault antibody database, the third fault antibody database and the fourth fault antibody database are calculated to obtain a sixth temporary deviation set. It is discovered that a deviation of the second diagnosing antigen and a fault antibody in the third fault antibody database is less than the third fault antibody threshold, deviations of the second diagnosing antigen and fault antibodies in the first fault antibody database are greater than the first fault antibody threshold, deviations of the second diagnosing antigen and fault antibodies in the second fault antibody database are greater than the second fault antibody threshold and deviations of the second diagnosing antigen and fault antibodies in the fourth fault antibody database are greater than the fourth fault antibody threshold. Thus a message indicating that there is a third type of fault is shown in the user interface. In step S219, a manual diagnosing result is generated, indicating that a third type of fault occurs. In step S220, the type of fifth fault may be selected and confirmed. And then, in step S223, the historical fault sample set is updated according to online operation data in an eighth period of time (from 10 seconds earlier than a time when the fifth fault is detected to a current time) and the third fault immune coefficient is updated. And then, the first fault antibody database, the second fault antibody database, the third fault antibody database and the fourth fault antibody database are updated and the first fault antibody threshold, the second fault antibody threshold, the third fault antibody threshold and the fourth fault antibody threshold are calculated.

Diagnosing results in this embodiment are shown in table 2.

TABLE 2

| | technological | type | occurring | detecting | diagnosing |
|---|---|---|---|---|---|
| No. | process | of fault | time | time | result |
| 1 | start-up | normal | — | — | normal |
| | procedure | | | | |
| 2 | steady-state | normal | — | — | normal |
| | operation | | | | |
| | procedure | | | | |
| 3 | start-up | first type | 990 s | 1005 s | first type |
| | procedure | of fault | | | of fault |
| 4 | start-up | third type | 420 s | 431 s | third type |
| | procedure | of fault | | | of fault |
| 5 | steady-state | second type | 1932 s | 1968 s | second type |
| | operation | of fault | | | of fault |
| | procedure | | | | |
| 6 | steady-state | fourth type | 1369 s | 1380 s | fourth type |
| | operation | of fault | | | of fault |
| | procedure | | | | |

With the fault diagnosis method according to embodiments of the present disclosure, the problem that there is a lack of historical data of a diagnostic object may be overcome, a production equipment or a technological process similar to the diagnostic object may be defined as a transplant provider of the vaccine transplantation, original antibodies of an artificial immune system of the diagnostic object may be generated with normal data and fault data in the historical data of the transplant provider, and a fault diagnosis of the diagnostic object may be performed based on the artificial immune system. With a method of generating an antigen, an antibody, an antigen database and an antibody database provided in the present disclosure, the original antibodies may be generated by using historical data of other equipments in a fault diagnosis process and massive diverse antibodies may be generated by a cloning technique or a variation process. Antibodies may be updated automatically in the fault diagnosis process and a requirement for the adaptability of a technological process may be satisfied, such that a fault occurring in the technological process may be discovered accurately and quickly and a type of the fault may be determined.

A fault diagnosis apparatus is provided. The apparatus includes a performing module, configured to perform a technological process of a diagnostic object to obtain an online operation data sample; an extracting module, configured to extract a first set of data in a first predetermined period from the online operation data sample as a detecting antigen; a first calculating module, configured to calculate deviations of the detecting antigen and all of normal antibodies in a normal antibody database to obtain a first deviation set; a judging module, configured to judge whether each deviation in the first deviation set is less than a normal antibody threshold; a first determining module, configured to determine that the technological process is normal if each deviation in the first deviation set is less than the normal antibody threshold, and to determine that there is a fault in the technological process if a deviation in the first deviation set is greater than or equal to the normal antibody threshold.

In some embodiments, the apparatus further includes: a second determining module, configured to determine a type of the fault in the technological process, if there is the fault in the technological process.

In some embodiments, the second determining module includes: a first obtaining unit, configured to obtain a diagnosing antigen according to the detecting antigen; a calculating unit, configured to calculate deviations of the diagnosing antigen and all of fault antibodies in a plurality of fault antibody databases to obtain a second deviation set; a first determining unit, configured to determine that the fault is a type of fault corresponding to the fault antibody database if there is a deviation of the diagnosing antigen and a fault antibody from a fault antibody database is less than a fault antibody threshold corresponding to the fault antibody database.

In some embodiments, the apparatus further includes: a generating module, configured to generate the normal antibody database and the plurality of fault antibody databases according to operation data of a transplant provider corresponding to the diagnostic object in a plurality of operating conditions and historical data of the diagnostic object in the plurality of operating conditions; wherein the generating module includes: a second determining unit, configured to determine the transplant provider according to process information, operating regulations and existing historical data of the diagnostic object; a first generating unit, configured to generate a normal sample set and a fault sample set according to the operation data of the transplant provider in the plurality of operating conditions; an extracting unit, configured to extract data used in a second predetermined period of time from the normal sample set to generate a normal vaccine, and to extract data in a third predetermined period of time from the fault sample set to generate a plurality of fault vaccines corresponding respectively to the plurality of types of faults; a second generating unit, configured to generate a historical normal sample set and a historical fault sample set according to the historical data of the diagnostic object in the plurality of operating conditions; a second obtaining unit, configured to obtain a first immune coefficient of the normal vaccine according to the historical normal sample set and the normal vaccine, and to generate the normal antibody database according to the normal vaccine and the first immune coefficient; a third obtaining unit, configured to obtain a plurality of second immune coefficients of the plurality of fault vaccines according to the historical fault sample set and the plurality of fault vaccines, and to generate the plurality of fault antibody databases according to the plurality of fault vaccines and the plurality of second immune coefficients.

In some embodiments, the technological process includes a start-up procedure and a steady-state operation procedure; the normal sample set comprises a first normal start-up sample set comprising normal data used in the start-up procedure of the transplant provider and a first normal steady-state sample set comprising normal data used in the steady-state operation procedure of the transplant provider; the historical normal sample set comprises a second normal start-up sample set comprising normal data used in the start-up procedure of the diagnostic object and a second normal steady-state sample set comprising normal data used in the steady-state operation procedure of the diagnostic object; the fault sample set comprises a first fault start-up sample set comprising fault data of a plurality of types of faults occurring in the start-up procedure of the transplant provider and a first fault steady-state sample set comprising fault data of the plurality of types of faults occurring in the steady-state operation procedure of the transplant provider; the historical fault sample set comprises a second fault start-up sample set comprising fault data of the plurality of types of faults occurring in the start-up procedure of the diagnostic object and a second fault steady sample set comprising fault data of the plurality of types of faults occurring in the steady-state operation procedure of the diagnostic object.

In some embodiments, obtaining a second immune coefficient of a fault vaccine according to the historical fault sample set and the fault vaccine in the start-up procedure includes: calculating a first deviation matrix according to the second normal start-up sample set and the second fault start-up sample set; calculating a second deviation matrix according to the normal vaccine and the fault vaccine; calculating the second immune coefficient according to the first deviation matrix and the second deviation matrix.

In some embodiments, obtaining a second immune coefficient of a fault vaccine according to the historical fault sample set and the fault vaccine in the steady-state operation procedure includes: calculating a third deviation matrix according to the second fault steady-state sample set; calculating a fourth deviation matrix according to the fault vaccine; calculating the second immune coefficient according to the third deviation matrix and the fourth deviation matrix.

In some embodiments, the first obtaining unit includes: a first obtaining sub-unit, configured to obtain a second set of data in an operating condition the same as a current operating condition from the second normal start-up sample set and calculating a fifth deviation matrix to obtain the diagnosing antigen according to the detecting antigen and the second set of data if the fault occurs in the second start-up procedure; a second obtaining sub-unit, configured to obtain the diagnosing antigen by subtracting operation data at a time when the fault is determined from each online operation data in the detecting antigen if the first fault occurs in the second steady-state operation procedure.

In some embodiments, the apparatus further includes: a first updating module, configured to update the normal antibody database through online operation data according to a comparison of the detecting antigen and the normal antibody database; a second updating module, configured to update the plurality of fault antibody databases through the online operation data according respectively to a plurality of comparisons of the diagnosing antigen and the plurality of fault antibody databases.

A computer readable storage medium is provided. The computer readable storage medium includes a computer program for executing the fault diagnosis method according to the above embodiments of the present disclosure, when running on a computer.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which should be understood by those skilled in the art.

It should be understood that the various parts of the present disclosure may be realized by hardware, software, firmware or combinations thereof. In the above embodiments, a plurality of steps or methods may be stored in a memory and achieved by software or firmware executed by a suitable instruction executing system.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The above-mentioned storage medium may be a read-only memory, a magnetic disc, an optical disc, etc.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated that the above embodiments are explanatory and cannot be construed to limit the present disclosure, and changes, alternatives, and modifications can be made in the embodiments without departing from scope of the present disclosure by those skilled in the art.

What is claimed is:

1. A fault diagnosis method, comprising:
performing a technological process of a diagnostic object to obtain an online operation data sample;
extracting a first set of data in a first predetermined period of time from the online operation data sample as a detecting antigen;
calculating deviations of the detecting antigen and all of normal antibodies in a normal antibody database to obtain a first deviation set, wherein the normal antibody database is generated according to operation data of a transplant provider corresponding to the diagnostic object in a plurality of operating conditions and historical data of the diagnostic object in the plurality of operating conditions;
determining whether each deviation in the first deviation set is less than a normal antibody threshold;
if each deviation in the first deviation set is less than the normal antibody threshold, determining that the technological process is normal, else determining that there is a fault in the technological process.

2. The method according to claim 1, further comprising:
determining a type of the fault in the technological process, if there is the fault in the technological process.

3. The method according to claim 2, wherein determining the type of the fault in the technological process comprises:
obtaining a diagnosing antigen according to the detecting antigen;
calculating deviations of the diagnosing antigen and all of fault antibodies in a plurality of fault antibody databases to obtain a second deviation set, wherein the plurality of fault antibody databases are generated according to the operation data of the transplant provider in the plurality of operating conditions and the historical data of the diagnostic object in the plurality of operating conditions;
if there is a deviation of the diagnosing antigen and a fault antibody from a fault antibody database is less than a fault antibody threshold corresponding to the fault antibody database, determining that the fault is a type of fault corresponding to the fault antibody database.

4. The method according to claim 3, wherein generating the normal antibody database and the plurality of fault antibody databases comprises:
determining the transplant provider according to process information, operating regulations and existing historical data of the diagnostic object;
generating a normal sample set and a fault sample set according to the operation data of the transplant provider in the plurality of operating conditions;
extracting data in a second predetermined period of time from the normal sample set to generate a normal vaccine, and extracting data in a third predetermined period of time from the fault sample set to generate a plurality of fault vaccines corresponding respectively to the plurality of types of faults;
generating a historical normal sample set and a historical fault sample set according to the historical data of the diagnostic object in the plurality of operating conditions;
obtaining a first immune coefficient of the normal vaccine according to the historical normal sample set and the normal vaccine, and generating the normal antibody database according to the normal vaccine and the first immune coefficient;
obtaining a plurality of second immune coefficients of the plurality of fault vaccines according to the historical fault sample set and the plurality of fault vaccines, and generating the plurality of fault antibody databases according to the plurality of fault vaccines and the plurality of second immune coefficients.

5. The method according to claim 4, wherein the technological process comprises a start-up procedure and a steady-state operation procedure,
the normal sample set comprises a first normal start-up sample set comprising normal data in the start-up procedure of the transplant provider and a first normal steady-state sample set comprising normal data in the steady-state operation procedure of the transplant provider;
the historical normal sample set comprises a second normal start-up sample set comprising normal data in the start-up procedure of the diagnostic object and a second normal steady-state sample set comprising normal data in the steady-state operation procedure of the diagnostic object;
the fault sample set comprises a first fault start-up sample set comprising fault data of a plurality of types of faults occurring in the start-up procedure of the transplant provider and a first fault steady-state sample set comprising fault data of the plurality of types of faults occurring in the steady-state operation procedure of the transplant provider;
the historical fault sample set comprises a second fault start-up sample set comprising fault data of the plurality of types of faults occurring in the start-up procedure of the diagnostic object and a second fault steady sample set comprising fault data of the plurality of types of faults occurring in the steady-state operation procedure of the diagnostic object.

6. The method according to claim 5, wherein obtaining a second immune coefficient of a fault vaccine according to the historical fault sample set and the fault vaccine in the start-up procedure comprises:
calculating a first deviation matrix according to the second normal start-up sample set and the second fault start-up sample set;
calculating a second deviation matrix according to the normal vaccine and the fault vaccine;
calculating the second immune coefficient according to the first deviation matrix and the second deviation matrix.

7. The method according to claim 5, wherein obtaining a second immune coefficient of a fault vaccine according to the historical fault sample set and the fault vaccine in the steady-state operation procedure comprises:
calculating a third deviation matrix according to the second fault steady-state sample set;
calculating a fourth deviation matrix according to the fault vaccine;
calculating the second immune coefficient according to the third deviation matrix and the fourth deviation matrix.

8. The method according to claim 5, wherein obtaining a diagnosing antigen according to the detecting antigen comprises:
if the fault occurs in the second start-up procedure, obtaining a second set of data in an operating condition the same as a current operating condition from the second normal start-up sample set and calculating a fifth deviation matrix to obtain the diagnosing antigen according to the detecting antigen and the second set of data;
if the fault occurs in the second steady-state operation procedure, obtaining the diagnosing antigen by subtracting operation data at a time when the fault is determined from each online operation data in the detecting antigen.

9. The method according to claim 3, further comprising:
updating the normal antibody database through online operation data according to a comparison of the detecting antigen and the normal antibody database; or
updating the plurality of fault antibody databases through the online operation data according respectively to a plurality of comparisons of the diagnosing antigen and the plurality of fault antibody databases.

10. A fault diagnosis apparatus, comprising:
a performing module, configured to perform a technological process of a diagnostic object to obtain an online operation data sample;
an extracting module, configured to extract a first set of data in a first predetermined period from the online operation data sample as a detecting antigen;
a first calculating module, configured to calculate deviations of the detecting antigen and all of normal antibodies in a normal antibody database to obtain a first deviation set;
a judging module, configured to judge whether each deviation in the first deviation set is less than a normal antibody threshold;
a first determining module, configured to determine that the technological process is normal if each deviation in the first deviation set is less than the normal antibody threshold, and to determine that there is a fault in the technological process if a deviation in the first deviation set is greater than or equal to the normal antibody threshold.

11. The apparatus according to claim 10, further comprising:
a second determining module, configured to determine a type of the fault in the technological process, if there is the fault in the technological process.

12. The apparatus according to claim 11, wherein the second determining module comprises:
a first obtaining unit, configured to obtain a diagnosing antigen according to the detecting antigen;
a calculating unit, configured to calculate deviations of the diagnosing antigen and all of fault antibodies in a plurality of fault antibody databases to obtain a second deviation set;
a first determining unit, configured to determine that the fault is a type of fault corresponding to the fault antibody database if there is a deviation of the diagnosing antigen and a fault antibody from a fault antibody database is less than a fault antibody threshold corresponding to the fault antibody database.

13. The apparatus according to claim 12, further comprising:
a generating module, configured to generate the normal antibody database and the plurality of fault antibody databases according to operation data of a transplant provider corresponding to the diagnostic object in a plurality of operating conditions and historical data of the diagnostic object in the plurality of operating conditions;
wherein the generating module comprises:
a second determining unit, configured to determine the transplant provider according to process information, operating regulations and existing historical data of the diagnostic object;
a first generating unit, configured to generate a normal sample set and a fault sample set according to the operation data of the transplant provider in the plurality of operating conditions;
an extracting unit, configured to extract data used in a second predetermined period of time from the normal sample set to generate a normal vaccine, and to extract data in a third predetermined period of time from the fault sample set to generate a plurality of fault vaccines corresponding respectively to the plurality of types of faults;
a second generating unit, configured to generate a historical normal sample set and a historical fault sample set according to the historical data of the diagnostic object in the plurality of operating conditions;
a second obtaining unit, configured to obtain a first immune coefficient of the normal vaccine according to the historical normal sample set and the normal vaccine, and to generate the normal antibody database according to the normal vaccine and the first immune coefficient;
a third obtaining unit, configured to obtain a plurality of second immune coefficients of the plurality of fault vaccines according to the historical fault sample set and the plurality of fault vaccines, and to generate the plurality of fault antibody databases according to the plurality of fault vaccines and the plurality of second immune coefficients.

14. The apparatus according to claim 13, wherein the technological process comprises a start-up procedure and a steady-state operation procedure;
the normal sample set comprises a first normal start-up sample set comprising normal data used in the start-up procedure of the transplant provider and a first normal steady-state sample set comprising normal data used in the steady-state operation procedure of the transplant provider;
the historical normal sample set comprises a second normal start-up sample set comprising normal data used in the start-up procedure of the diagnostic object and a second normal steady-state sample set comprising normal data used in the steady-state operation procedure of the diagnostic object;
the fault sample set comprises a first fault start-up sample set comprising fault data of a plurality of types of faults occurring in the start-up procedure of the transplant provider and a first fault steady-state sample set comprising fault data of the plurality of types of faults occurring in the steady-state operation procedure of the transplant provider;
the historical fault sample set comprises a second fault start-up sample set comprising fault data of the plurality of types of faults occurring in the start-up procedure of the diagnostic object and a second fault steady sample set comprising fault data of the plurality of types of faults occurring in the steady-state operation procedure of the diagnostic object.

15. The apparatus according to claim 14, wherein obtaining a second immune coefficient of a fault vaccine according to the historical fault sample set and the fault vaccine in the start-up procedure comprises:
calculating a first deviation matrix according to the second normal start-up sample set and the second fault start-up sample set;
calculating a second deviation matrix according to the normal vaccine and the fault vaccine;
calculating the second immune coefficient according to the first deviation matrix and the second deviation matrix.

16. The apparatus according to claim 14, wherein obtaining a second immune coefficient of a fault vaccine according to the historical fault sample set and the fault vaccine in the steady-state operation procedure comprises:
calculating a third deviation matrix according to the second fault steady-state sample set;
calculating a fourth deviation matrix according to the fault vaccine;
calculating the second immune coefficient according to the third deviation matrix and the fourth deviation matrix.

17. The apparatus according to claim 14, wherein the first obtaining unit comprises:
a first obtaining sub-unit, configured to obtain a second set of data in an operating condition the same as a current operating condition from the second normal start-up sample set and calculating a fifth deviation matrix to obtain the diagnosing antigen according to the detecting antigen and the second set of data if the fault occurs in the second start-up procedure;
a second obtaining sub-unit, configured to obtain the diagnosing antigen by subtracting operation data at a time when the fault is determined from each online operation data in the detecting antigen if the first fault occurs in the second steady-state operation procedure.

18. The apparatus according to claim 12, further comprising:
a first updating module, configured to update the normal antibody database through online operation data according to a comparison of the detecting antigen and the normal antibody database;
a second updating module, configured to update the plurality of fault antibody databases through the online operation data according respectively to a plurality of comparisons of the diagnosing antigen and the plurality of fault antibody databases.

19. A computer readable storage medium, comprising a computer program for executing steps of:
performing a technological process of a diagnostic object to obtain an online operation data sample;
extracting a first set of data in a first predetermined period from the online operation data sample as a detecting antigen;
calculating deviations of the detecting antigen and all of normal antibodies in a normal antibody database to obtain a first deviation set, wherein the normal antibody database is generated according to operation data of a transplant provider corresponding to the diagnostic object in a plurality of operating conditions and historical data of the diagnostic object in the plurality of operating conditions;
determining whether each deviation in the first deviation set is less than a normal antibody threshold;
if each deviation in the first deviation set is less than the normal antibody threshold, determining that the technological process is normal, else determining that there is a fault in the technological process.
